(19) United States
(12) Patent Application Publication
(10) Pub. No.: US 2009/0173616 A1
(43) Pub. Date: Jul. 9, 2009

(54) Water Ionizing System

(76) Inventors: Rick Henry Cabados, Encinitas, CA (US); Geoffrey Poole, San Marcos, CA (US); Lior Shafir, Elm Vered (IL)

Correspondence Address: ERIC HANSCOM, 7395 PORTAGE WAY, CARLSBAD, CA, 92011, US

(21) Appl. No.: 11/970,136

(22) Filed: Jan. 7, 2008

(51) Int. Cl. C02F 9/12

(52) U.S. Cl. 202/176; 210/259; 210/202; 210/170.08; 210/85

(57) ABSTRACT

This invention is directed toward a water ionizing system which combines a traditional water ionizing machine with a reverse osmosis machine and mineral filter. The invention can be configured several different ways, with the goal of purifying the water through the reverse osmosis component, optionally sanitizing it with UV light, then remineralizing the water with the mineral filter, and finally ionizing and alkalizing the water with the water alkaline ionizing machine. The result is purified water from which all impurities have been removed, but which also contains helpful minerals and is alkalized and ionized. The invention also provides means by which the pH of the water can be raised up to 3 pH points.

### CROSS REFERENCE TO RELATED APPLICATIONS

None.

### STATEMENT REGARDING FEDERALLY SPONSORED RESEARCH OR DEVELOPMENT

This invention was not federally sponsored.

### BACKGROUND OF THE INVENTION

This invention is directed toward a unique water purification, optional disinfecting, re-mineralization and optional electrolysis treatment for use in drinking water (human and animals), horticulture, and commercial/industrial applications. The invention can be configured several different ways, with the goal of purifying the water through the reverse osmosis component, and optionally sanitizing it with UV light, then re-mineralizing the water with liquid or granular mineral filters, and finally optionally alkalizing and electrolyzing with an electric-based water ionizing machine. The result is water from which all impurities have been removed and disinfected by optional ultra violet treatment, but which also contains never before seen amounts of beneficial alkaline helpful minerals and/or powerful anti-oxidants. Without adding the minerals, the machine would not ionize and alkalize the water as efficiently. This unique combination of reverse osmosis, with optional UV, will create very pure water that can then have liquid or granular minerals added, and be alkalized and ionized to make it very healthy for human consumption as well as other application outlined above.

It is desirable to produce water that has a pH of 7 or higher (a pH of 7 is neutral). It has been shown that a pH below 7 will cause corrosion in metal pipes carrying water. Additionally, the ideal pH of water for human consumption is generally considered to be in the range of 8 to 10, as acidic water has been determined to be the root cause of many diseases. Past reverse osmosis systems have produced slightly to severely acidic water, with a pH of between 4 and 6. To bring the pH up to 7, a form of calcium called Calcite has been added to the water to raise the pH. The invention also provides means by which the pH of water can be brought up dramatically higher for optimal health benefits. There are two basic devices that can accomplish this reaction. First, specially designed and produced ceramic beads, specifically designed to increase pH and add anti-oxidants to drinking water. Second, a system can inject liquid or infuse granular minerals and anti-oxidants into the water after it passes through the reverse osmosis portion of the invention but before the water exits the faucets. The re-mineralized and anti-oxidant rich water is then run through an optional electric based electrolysis system. This technology can be designed in small residential point of use systems, water dispensers/vending machines, animal rearing, horticulture and large commercial/industrial applications.

The desire for purified water has been present for many years. Early attempts at purifying water date back to 2,000 B.C. when early Sanskrit writings discussed methods of purifying water, including boiling, placing heated metal objects in the water prior to consumption, and filtering through basic sand and/or charcoal filters. Centuries later, Hippocrates performed his own water purification experiments using a cloth bag, later known as the Hippocrates sleeve, which would trap sediments from water and improve the taste and smell of the water.

In the Middle Ages, desalination experiments using sand filters were performed by Sir Francis Bacon and, although they failed, provided not only the basic equipment and theories, but also the inspiration for future generations of scientists and innovators. The next leap in technology came during the Renaissance with the advent of the microscope and the earlier reliance upon concave pieces of glass to magnify objects. Soon, it became obvious that a single drop of water contained a myriad of different types of plant and animal life, and intelligent minds concluded that not all these forms of life were beneficial to humans who consumed the water. In the mid-1800s, government officials in London began to connect the spread of deadly cholera with the poor quality of the drinking water. Upon installing sand filters between the source of drinking water and the end users, London city officials found that the incidence of cholera decreased significantly. The British scientist John Snow examined some water contaminated by a sewage leak and linked several cholera deaths to cholera bacteria

Snow's discovery led to a widespread increase in the use of sand filters, and was responsible for the beginnings of municipal water treatment. The French in particular, began to demand clean water as a “right” of citizenship. While most cities relied on the sand filters, problems with large scale sand filters began to make themselves obvious. They required extensive cleaning, and became clogged frequently, requiring a substantial amount of time just to maintain their filtering capacity. The idea, however, of a municipal water treatment system, installed and maintained by governmental officials, had taken hold and was not to pass out of popularity.

The next major improvement was the use of chlorine to treat drinking water, a method that remains popular today, with nearly 99% of all municipal water treatment facilities using chlorine or chlorine combined with ammonia to sanitize their water. However, since chlorine is officially listed as a “poison,” finding other methods of purifying water was desirable. As governments have proven incapable of providing drinking water of a quality that many desire, the popularity of individual purification units sold for use in a single home have become more and more popular.

As technology progressed, reverse osmosis systems became popular whereby tap water was forced through a semi-permeable membrane that let through water molecules and strained out all other molecules. While it was beneficial to remove some “impurities”, such as microscopic viruses and bacteria, toxic metals, and other harmful components of untreated water, the reverse osmosis filters also removed the beneficial minerals that humans require for body maintenance and growth. Since many of these minerals are required in only trace amounts, drinking water containing these minerals is an easy way to consume the suggested minimum daily requirements. Thus, reverse osmosis machines performed both beneficial and harmful operations on drinking water.

Another method of treating water that has become popular over the past several years has been to ionize water. Water ionizing can be accomplished with specially designed ceramic beads and/or electrolysis machines to separate out high pH water from low pH water. Low pH, acidic water is generally considered good for cleaning and disinfecting, while high pH, alkaline water is desirable for drinking, as it more effectively creates anti-oxidant rich water to flush out acidic compounds in the body and micro clusters of water molecules which are absorbed more readily by the body and facilitate absorption of minerals and nutrients.

An additional treatment method for water is to apply ultraviolet radiation to untreated water. Ultraviolet radiation will kill most living organisms in water, such as bacteria and viruses; harmful living organisms are killed before they are drank with water.

Liquid or granular remineralizing filters are an additional treatment option for tap water. While some purification methods, such as reverse osmosis, remove all impurities from water, including good impurities like beneficial minerals, liquid or granular remineralization adds these good impurities back into the treated water.

The main problem facing consumers of purified water is that while all of the various treatment methods and machines modify tap water in some manner prior to its being consumed, none provide a clean water, free of debris and living organisms, with desirable amounts of minerals remaining in the water, where the water can be adjusted as to pH content and also ionize the water. Thus there has existed a long-felt need for a system as provided by this invention.

The system in its theoretical state is a water purification system which uses some combination of water ionizers, sanitization devices, reverse osmosis filters, remineralizers, distillers, pH-modifying devices, and flavoring systems to provide purified water which is pleasant tasting, purified, fortified with beneficial minerals, and of a beneficial pH at or above 7. The invention can be configured several different ways, with the goal of purifying the water through the reverse osmosis component, and optionally sanitizing it with UV light, then remineralizing the water, and finally alkalizing and ionizing the water with optional electrolysis. The result is purified water from which all impurities have been removed, but which also contains helpful minerals. Without adding the minerals, the machine would not ionize and alkalize the water. This unique combination of reverse osmosis, with optional UV, will create very pure water that can then have minerals added, and be alkalized and ionized to make it very healthy for human consumption.

There are several different types of water systems upon which the invention can work including residential point of use system, dispensing/vending machines, agriculture, animal rearing and commercial/industrial applications. For example, there are many commercial water machines, normally approximately six feet high and four feet wide, which produce “purified” water for consumer consumption. Many of these machines have mere filters or reverse osmosis only systems in between the source of regular tap water and the faucet from which the “purified” water is sold. The invention provides a substantial improvement over such systems as the addition of small, compact optional electrolysis machines and remineralizers with, optionally, reverse osmosis units and distillers, would provide water that has not only been purified, but also contains beneficial minerals and comes out of the tap with higher pH. The commercial water machines have pumps built in to force the tap water through any existing purification or filtering devices and out the dispensing faucet. Thus, it would not require substantial effort or cost to splice the invention into the existing water line and allow the pre-existing pump to force the tap water through the invention before dispensing the purified water through the faucet.

A further improvement in the commercial vending machine is to add flavors to the water as it is released from the faucet. Flavored water is extremely popular, as evidenced by the large number of companies that sell water with various flavorings. Because the flavorings would be added after the last water modification unit in the series of such units between the source of water and the faucet, there is no need to store different types of water with different flavors.

The same design can also be incorporated to a smaller water dispenser. Many offices, waiting rooms, and even homes have small stands, usually three to four feet high, upon which a small water container (usually five gallons) can be placed upside down or a direct water feed. The water then flows, by gravity, out a faucet when a button is depressed. Most of these smaller units merely dispense the water which has been purchased; few modify the water in any way. Since mineralizers, ionizers, reverse osmosis units and distillers can all be made in very small and compact sizes and shapes, it is feasible to build these units into the body of one of these small stands.

The ionizer and other electronics of the system emit electromagnetic radiation. To reduce these emissions, the electrical section of the system can be surrounded with layers of metallic foil, preferably made from nickel, cobalt, iron, or tin. At least nine layers of metallic foil are preferably used to significantly reduce the amount of electromagnetic radiation emitted from the system.

### SUMMARY OF THE INVENTION

It is a principal object of the invention to provide one apparatus that can filter, ionize, mineralize, optionally electrolyze, and, optionally, flavor water for human consumption.

It is another object of the invention to provide one machine capable of all of these various operations that is less costly and takes up less space than purchasing one of each of the machines currently on the market, which are capable of performing one of these functions.

A further object of this invention is to provide a single unit which can be spliced into the existing water supply to a fixed structure, or structures, to provide a variety of water filtration, purification, and remineralization functions within a conveniently sized and shaped container.

Additional objects of the invention include providing a small, compact unit that can be spliced or manufactured into the water supply running through a commercial water vending machine.

Another object of the invention is to provide a small, compact unit that can be spliced, or manufactured, into the existing water supply of a small, portable water dispensing machine.

It is a final object of this invention that the base unit offers the user several flexible options, including UV treatment, distillation, and other treatment methods which can be included in the base unit or added to it with minimal inconvenience.

It should be understood the while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

FIG. 1 is a machine with a combination of a reverse osmosis filter, and a remineralizer to create the final water product.

FIG. 2 is a machine with a combination of a reverse osmosis filter, a remineralizer, and an ionizer to create the final water product.

FIG. 3 is a machine with a combination of a reverse osmosis filter, an ultraviolet purifier, a remineralizer, and an ionizer to create the final water product.

FIG. 4 is a machine with a combination of a reverse osmosis filter, a distiller, a remineralizer, and an ionizer to create the final water product.

FIG. 5 is a combination of tap water, a distiller, a remineralizer, and an ionizer to create the final water product.

FIG. 6 is a combination of tap water, a distiller, and a remineralizer to create the final water product.

FIG. 7 is a combination of tap water, a distiller, a remineralizer, an ionizer, a flavoring system, a heater, and a cooler to create the final water product.

### DETAILED DESCRIPTION OF THE INVENTION

The invention is basically a combination of known elements into one shielding compartment. While there are a number of difference sizes and configurations possible for the shielding compartment, a preferred embodiment of the invention is a rectangular unit with stainless steel or a similarly fashionable and durable exterior, plenty of room in the interior for the various components, and one or more nozzles from which the purified, remineralized and optionally electrolyzed water is emitted. The face of the compartment can house a wide variety of dials and gauges, depending on how much control the user is given over the eventual product. The size of the unit depends upon the intended audience. For example, a commercial unit intended to be placed in front of a supermarket may measure six feet high and have spring-loaded vending chamber doors to keep the area in which water purchasers place their containers free from dust. The power supply needed to operate such a machine is also dependant upon its size, and the use of emergency battery backup systems is contemplated by the inventor.

Because of the inventor's selection of the elements, there are a number of different orders in which the individual elements can appear in a line between tap water and the final product. Several of the preferred embodiments of the invention are laid out below:

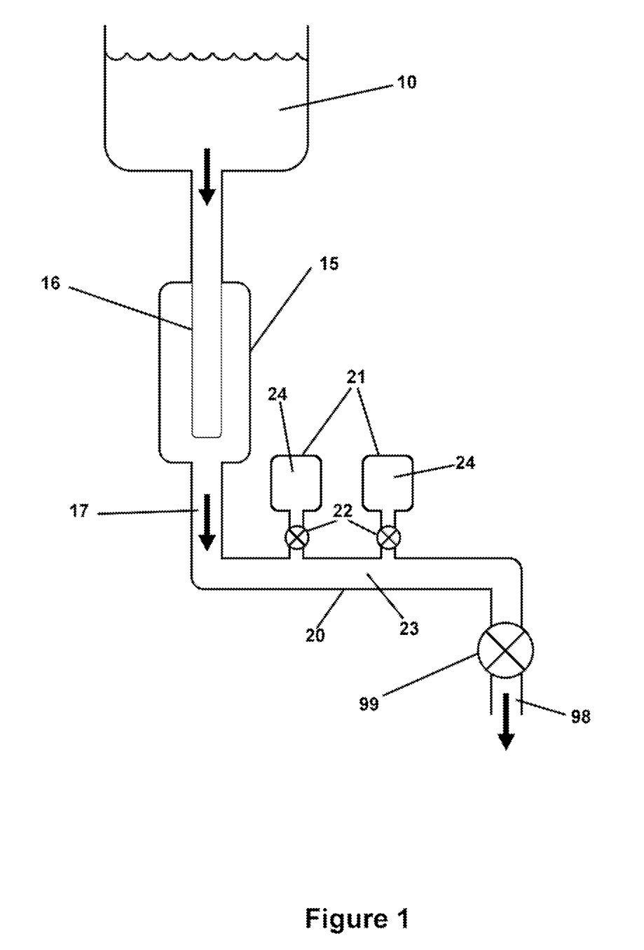

FIG. 1 is a machine with a combination of a reverse osmosis filter, and a remineralizer to create the final water product. Tap water 10 flows into a reverse osmosis filter 15. In the reverse osmosis filter 15, the tap water 10 passes through a thin membrane 16, which removes impurities. Water that exits the reverse osmosis filter 17 travels to a remineralizer 20. In this embodiment, the remineralizer 20 has minerals 24 located in containers 21. Regulating devices 22 regulate the amount of minerals 24 that are added to water in the remineralizer 23. The water that exits the remineralizer 20 is the final water product 98 that exits the device through a valve 99, which regulates the flow of final water product 98 from the base unit.

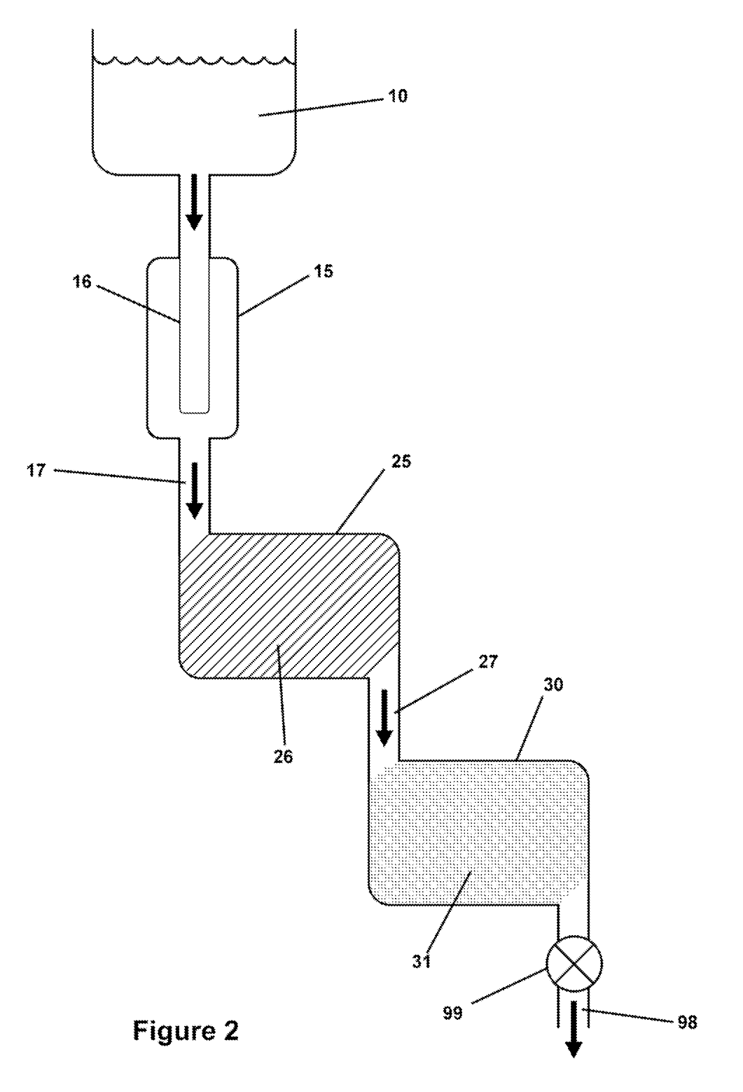

FIG. 2 is a machine with a combination of a reverse osmosis filter, a remineralizer, and an ionizer to create the final water product. Tap water 10 flows into a reverse osmosis filter 15. In the reverse osmosis filter 15, the tap water 10 passes through a thin membrane 16, which removes impurities. Water that exits the reverse osmosis filter 17 travels to a remineralizer 25. In this embodiment, the water from the reverse osmosis filter 17 travels through the remineralizer 25, which contains minerals 26. The water that exits the remineralizer 27 now contains minerals that it would not have had had the water that exits the reverse osmosis filter 17 not passed through the remineralizer 25. The water that exits the remineralizer 27 then travels through an ionizer 30, where the ionizer 30 raises the pH of water. In this embodiment, water that passes through the ionizer 30 travels through ceramic beads 31 that raise the pH of the water. The water that exits the ionizer 32 has a higher pH than it would have had had the water that exits the remineralizer 27 not passed through the ionizer 30. The final water product 98 then exits the device through a valve 99, which regulates the flow of final water product 98 from the device.

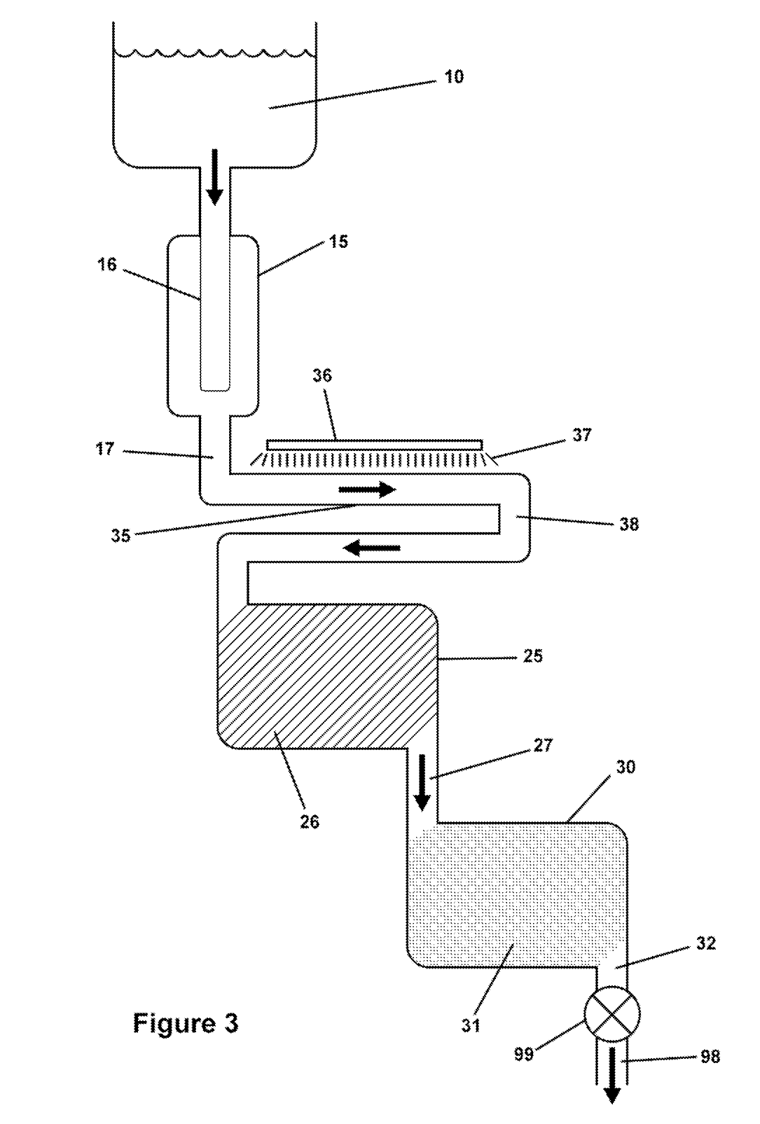

FIG. 3 is a machine with a combination of a reverse osmosis filter, an ultraviolet purifier, a remineralizer, and an ionizer to create the final water product. Tap water 10 flows into a reverse osmosis filter 15. In the reverse osmosis filter 15, the tap water 10 passes through a thin membrane 16, which removes impurities. Water that exits the reverse osmosis filter 17 travels to an ultraviolet purifier 35. The ultraviolet purifier 35 acts as a sanitation device and uses ultraviolet radiation 37 to purify water. A source for ultraviolet light 36 emits ultraviolet radiation 37 to purify the water that exits the reverse osmosis filter 17. The water that leaves the ultraviolet purifier 38 has lower levels of harmful bacteria and viruses than it would have had had the water that exits the reverse osmosis filter 17 not traveled through the ultraviolet purifier 35. The water that exits the ultraviolet purifier 38 then travels to a remineralizer 25. In this embodiment, the water from the reverse osmosis filter 17 travels through the remineralizer 25, which contains minerals 26. The water that exits the remineralizer 27 now contains minerals that it would not have had had the water that exits the ultraviolet purifier 38 not passed through the remineralizer 25. The water that exits the remineralizer 27 then travels through an ionizer 30, where the ionizer raises the pH of the water. In this embodiment, water that passes through the ionizer 30 travels through ceramic beads 31 that raise the pH of the water. The water that exits the ionizer 32 has a higher pH than it would have had the water from the remineralizer 27 not passed through the ionizer 30. The final water product 98 then exits the device through a valve 99, which regulates the flow of final water product 98 from the device.

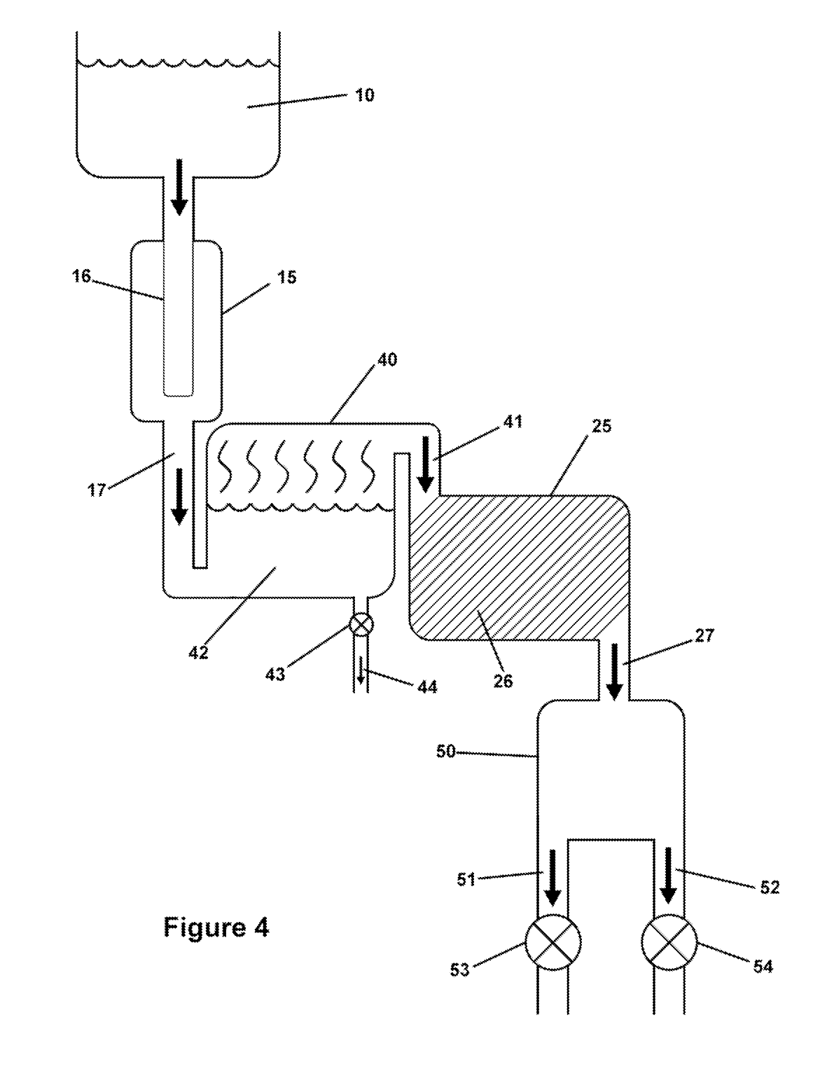

FIG. 4 is a machine with a combination of a reverse osmosis filter, a distiller, a remineralizer, and an ionizer to create the final water product. Tap water 10 flows into a reverse osmosis filter 15. In the reverse osmosis filter 15, the tap water 10 passes through a thin membrane 16, which removes impurities. Water that exits the reverse osmosis filter 17 travels to a distiller 40. The water in the distiller 42 is heated, and purified water leaves the distiller 40. The distiller can have an optional valve 43 where wastewater 44 can be drained from the distiller 40. The water that exits the distiller 41 travels to a remineralizer 25. In this embodiment, the water from the reverse osmosis filter 17 travels through the remineralizer 25, which contains minerals 26. The water that exits the remineralizer 27 now contains minerals that it would not have had had the water that exits the distiller 41 not passed through the remineralizer 25. The water that exits the remineralizer 27 then travels through an ionizer 50, where the ionizer raises the pH of water. In this embodiment, electrolysis can be used in the ionizer 50 to separate the water into low pH water 51 and high pH water 52. A low pH valve 53 is used to regulate the flow of low pH water 51 that exits the device. A high pH valve 54 is used to regulate the flow of high pH water 52 that exits the device.

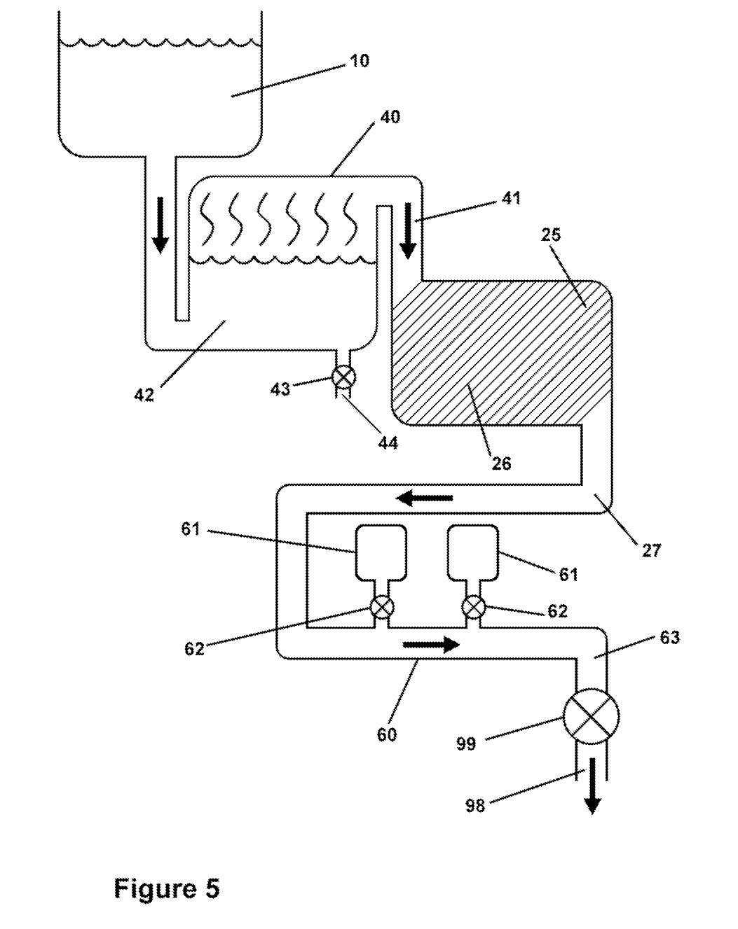

FIG. 5 is a combination of tap water, a distiller, a remineralizer, and an ionizer to create the final water product. Tap water 10 flows into a distiller 40. The water in the distiller 42 is heated, and purified water leaves the distiller 40. The distiller can have an optional valve 43 where wastewater 44 can be drained from the distiller 40. The water that exits the distiller 41 travels to a remineralizer 25. In this embodiment, the water from the reverse osmosis filter 17 travels through the remineralizer 25, which contains minerals 26. The water that exits the remineralizer 27 now contains minerals that it would not have had had the water that exits the distiller 41 not passed through the remineralizer 25. The water that exits the remineralizer 27 then travels through an ionizer 60, where the ionizer raises the pH of water. In this embodiment, minerals are added to water to increase the pH of the water. Minerals are stored in containers 61. Valves 62 control the flows of these minerals from the containers 61 to the water. The amount and type of minerals added to the water controls how much the pH of the water is raised or lowered. The water that leaves the ionizer 63 is the final water product 98, which exits the device through a valve 99, which regulates the flow of final water product 98 from the device.

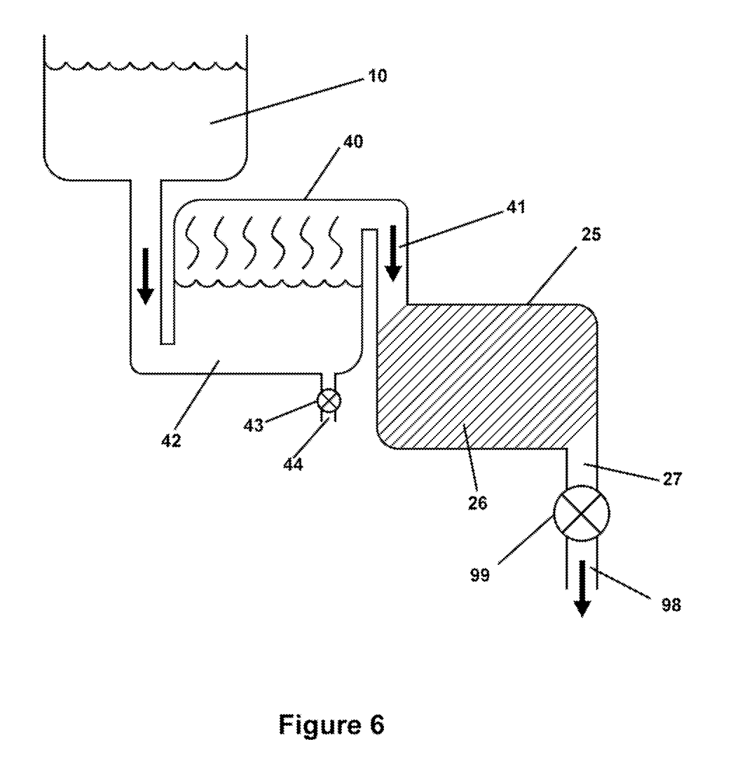

FIG. 6 is a combination of tap water, a distiller, and a remineralizer to create the final water product. Tap water 10 flows into a distiller 40. The water in the distiller 42 is heated, and purified water leaves the distiller 40. The distiller can have an optional valve 43 where wastewater 44 can be drained from the distiller 40. The water that exits the distiller 41 travels to a remineralizer 25. In this embodiment, the water from the reverse osmosis filter 17 travels through the remineralizer 25, which contains minerals 26. The water that exits the remineralizer 27 now contains minerals that it would not have had had the water that exits the distiller 41 not passed through the remineralizer 25. The water that leaves the remineralizer 27 is the final water product 98, which exits the device through a valve 99, which regulates the flow of final water product 98 from the device.

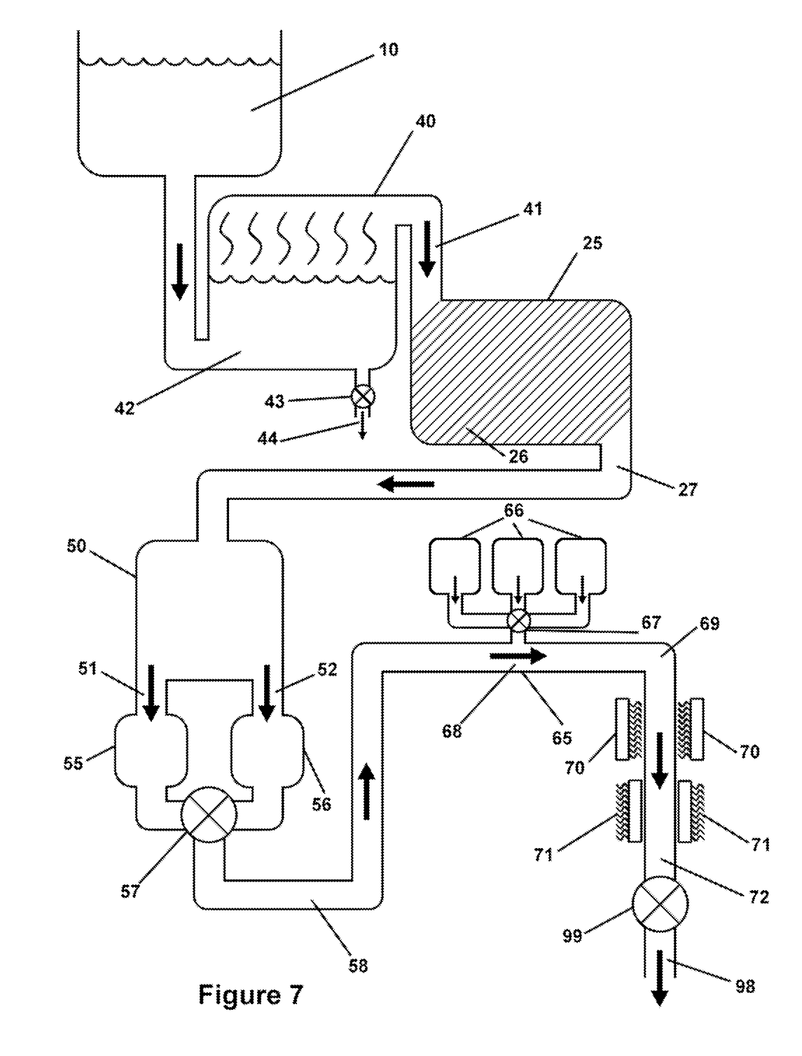

FIG. 7 is a combination of tap water, a distiller, a remineralizer, an ionizer, a flavoring system, a heater, and a cooler to create the final water product. Tap water 10 flows into a distiller 40. The water in the distiller 42 is heated, and purified water leaves the distiller 40. The distiller can have an optional valve 43 where wastewater 44 can be drained from the distiller 40. The water that exits the distiller 41 travels to a remineralizer 25. In this embodiment, the water from the reverse osmosis filter 17 travels through the remineralizer 25, which contains minerals 26. The water that exits the remineralizer 27 now contains minerals that it would not have had had the water that exits the distiller 41 not passed through the remineralizer 25. The water that exits the remineralizer 27 then travels through an ionizer 50, where the ionizer separates water into water with a low pH 51 and water with a high pH 52. This water is then stored in tanks, where the low pH water 51 is stored in tank 55 and the high pH water 52 is stored in tank 56. A valve 57 regulates the flow of water from tank 55 and tank 56, and combines them into one flow of water that exits the ionizer 58. The user, by directly or indirectly controlling the valve 57, can regulate the pH level of the water that exits the ionizer 58. The water that exits the ionizer 58 then travels to a flavoring device 65. This device contains different compartments 66 that stores flavor additives. A valve 67, or alternatively an injector, controls which flavor additives are added to the flow of water 68. A meter can be included to regulate the amount of flavoring that is added to the flow of water 68. Alternatively, the flavoring device 65 can add herbs or other supplements to the flow of water 68. The water that exits the flavoring device 69 then can pass through a heater 70 and a cooler 71. If the water needs to be heated, then the heater 70 is activated and raises the temperature of the water. If the water needs to be cooled, then the cooler 71 is activated and lowers the temperature of the water. The water that exits the cooler 72 is the final water product 98, which exits the device through a valve 99, which regulates the flow of final water product 98 from the device.

Among additional water treatment options which can be easily contained within the base unit are switches by which a user of the invention can change the pH of the water emitting from the machine. Further optional equipment could include temperature dials, which would allow a user to change the temperature of the water, separate nozzles for cold and hot water, or one nozzle that combines both and is adjustable. Solar panels can be used to partially or fully power the unit, or act as back up power. The machine can also include a monitor, where the monitor is connected to a video source, such as a DVD player, and can display promotional material to users.

It is also possible to use the wastewater produced by the machine. Wastewater can be produced by the machine at various stages, such as from the reverse osmosis filter or the ionizer. This water can be redirected to residential or commercial gray water systems for use in applications such as landscape irrigation, toilet water, or industrial application.

Further, words with positive connotation can be located on surfaces that contain water to increase the positive effects of the water. Many in the alternative health field believe that when words with positive connotations are placed on water, the vibration of the water changes. For example, some theorize that if the word “war” is placed on a glass of water and then frozen, the water will freeze into ice with ice crystals that are non-symmetrical and fractured. If, however, the word “love” is placed on a glass of water and then frozen, the water will freeze into ice with ice crystals that are symmetrical and balanced.

What I claim is:

1. A device for purifying water, comprising: a source of tap water, a reverse osmosis unit, an ionizing unit, and a remineralizing unit,
where the reverse osmosis unit, the ionizing unit, and the remineralizing unit are coupled to one another in a series connection plan, where one of the reverse osmosis unit, the ionizing unit, or the remineralizing unit is coupled to the source of tap water and the other units are coupled, in series configuration, such that the tap water passes through all three units before being emitted from the device, and additionally comprising a means of emitting the water from the device.

2. The device of claim 1, additionally comprising an ultraviolet unit which purifies the water by exposing it to ultraviolet light.

3. The device of claim 1, additionally comprising a distillation unit.

4. The device of claim 1, additionally comprising a second remineralizing unit.

5. The device of claim 1, additionally comprising means by which the pH of water can be brought up by at least two pH points.

6. The device of claim 5, where the means by which the pH of water can be brought up by at least two pH points is one or more ceramic beads, where the one or more ceramic beads are designed such that they increase the pH of the water and add anti-oxidants to the water.

7. The device of claim 5, where the means by which the pH of water can be brought up by at least two pH points is a liquid injector that can inject a wide array of minerals into the water after the water has passed through the reverse osmosis system.

8. The device of claim 1, additionally comprising a source of flavoring.

9. The device of claim 8, where the source of flavoring comprises one or more containers of concentrated flavoring, one or more tubes through which the flavoring can be injected into the water, and a metering device which determines how much of each of the one or more containers of concentrated flavorings is injected into the water at any one period of time.

10. The device of claim 8, where the flavoring comprises herbs.

11. The device of claim 1, additionally comprising means to adjust the temperature of the water through the use of one or more dials or other controls on the surface of the device.

12. The device of claim 1, additionally comprising means for securing a container which can be filled with water such that the container can be filled with water emitted from the device or fed directly from a water source.

13. The device of claim 1, additionally comprising battery and/or solar and/or alternative power means to supply an uninterrupted power supply.

14. The device of claim 1, additionally comprising means to oxygenate or super-oxygenate the water.

15. The device of claim 14, additionally comprising means to dehumidify the air used to oxygenate or super-oxygenate the water.

16. The device of claim 1, where the device produces wastewater that is not suitable for human consumption, where this water is redirected from the machine to residential or commercial wastewater use systems.

17. A device for purifying water, comprising: source of tap water, a reverse osmosis unit, an ionizing unit, a remineralizing unit, a means to adjust the pH of the water, and a means of emitting the water from the device
where the reverse osmosis unit, the ionizing unit, and the remineralizing unit are coupled to one another in a series connection plan, where one of the reverse osmosis unit, the ionizing unit, or the remineralizing unit is coupled to the source of tap water and the other units are coupled, in series configuration, such that the tap water passes through all three units before being emitted from the device,
where the order of the various units always has the reverse osmosis unit closer to the source of tap water than the ionizing unit and the remineralizing unit.
where the means to adjust the pH of the water is one or more dials or other controls on the surface of the device or built into the device and that automatically adjusts to preset conditions,
additionally comprising digital displays which identify and/or quantify one or more characteristics of the water, such as pH, oxidation reduction potential, temperature, or chemical content, with optional sound and/or smell capabilities.

18. The device of claim 17, where the device further comprises one or more layers of metallic foil that is placed around the ionizer, and
where the device further comprises one or more words with positive connotations located on one or more surfaces that contain water in the device.

19. The device of claim 17, additionally comprising one or more sediment filters, pre-carbon filters, reverse osmosis membranes, ultraviolet emitting devices, booster pumps, transformers, post-carbon filters, pressure reducers, drains, input openings, tank faucets,
where the device can also be designed to extract water out of the air and/or also remove unwanted components out of seawater and use this water within the device.

20. A device for purifying water, consisting of: a source of tap water, a reverse osmosis unit, an ionizing unit, a remineralizing unit, a second remineralizing unit, an ultraviolet unit, a distillation unit, a means to adjust the pH of the water, a source of flavoring, and a means of emitting the water from the device,
where the reverse osmosis unit, the ionizing unit, and the remineralizing unit are coupled to one another in a series connection plan, where one of the reverse osmosis unit, the ionizing unit, or the remineralizing unit is coupled to the source of tap water and the other units are coupled, in series configuration, such that the tap water passes through all three units before being emitted from the device,
where the order of the various units always has the reverse osmosis unit closer to the source of tap water than the ionizing unit and the remineralizing unit,
where the ultraviolet unit purifies water by exposing it to ultraviolet light,
where the source of flavoring comprises one or more containers of concentrated flavoring, one or more tubes through which the flavoring can be injected into the water, and a metering device which determines how much of each of the one or more containers of concentrated flavorings is injected into the water at any one period of time.
where the device additionally comprising means by which the pH of water can be brought up by at least two pH points.
